(19) United States
(12) Patent Application Publication
(10) Pub. No.: US 2005/0056033 A1
(43) Pub. Date: Mar. 17, 2005

(54) Walk-in refrigeration unit control and monitoring system

(76) Inventor: Jean-Pierre Gingras, Longueuil (CA)

Correspondence Address: OGILVY RENAULT, 1981 MCGILL COLLEGE AVENUE, SUITE 1600, MONTREAL, QC, H3A2Y3, CA

(21) Appl. No.: 10/889,299

(22) Filed: Jul. 13, 2004

(30) Foreign Application Priority Data
Feb. 21, 2003 (CA) 2,419,647

(51) Int. Cl. G01K 13/00; F25D 21/06; G05D 23/32; F25B 41/00; F25B 49/00

(52) U.S. Cl. 62/129; 62/155; 62/157

(57) ABSTRACT

A method for monitoring and controlling of a walk-in refrigeration unit is provided. The method comprises setting at least one of a threshold and timing control values associated to operating modes of the refrigeration unit, receiving at a controller unit operating parameters representative of a condition of at least one of an accessory unit, an environment and a heat exchange unit and controlling a functioning of at least one of the accessory unit and the heat exchange unit according to the control values and the received operating parameters. Other features include communication and data logging capabilities.

### CROSS-REFERENCE TO RELATED APPLICATIONS

This application claims priority under 35USC§120 of U.S. patent application Ser. No. 10/781,853, filed on Feb. 20, 2004 and which claims priority under 35USC§119(e) of U.S. provisional patent application 60/448,493, filed on Feb. 21, 2003 and which also claims priority under 35USC§119(a)-(d) of Canadian patent application 2,419,647, filed on Feb. 21, 2003, the specifications of which are hereby incorporated by reference.

### FIELD OF THE INVENTION

The present invention relates to a walk-in refrigeration unit control and monitoring method and system.

### BACKGROUND OF THE INVENTION

The device described in U.S. Pat. No. 6,401,466 B1 (hereby incorporated by reference) is a good example of the present state-of-the-art in the field of walk-in refrigeration units. Many improvements can be made to such existing devices to render walk-in refrigeration units more efficient.

In order to answer today's needs in food safety programs such as HACCP, it becomes essential to monitor and record the different parameters in a walk-in refrigeration unit. Advances in microprocessors and associated technologies for control and monitoring are not fully exploited.

There is therefore a need in the industry to provide such improved systems, methods and devices.

### SUMMARY OF THE INVENTION

It is an object of the present invention to provide a single module to manage more efficiently and accurately the different elements/parameters of a cold room, such as refrigeration control, defrost control, fan control, temperatures & pressures monitoring.

It is another object of the present invention to provide a method and a device with energy saving features through improved light control and an anti-sweat heating element.

It is yet another object of the present invention to provide a method and a device allowing for easier maintenance and traceability by logging of the device operating parameters.

According to a first broad aspect of the present invention, there is provided a method for monitoring and controlling a walk-in refrigeration unit, comprising: setting threshold and timing control values associated to operating modes of the refrigeration unit; receiving at a controller unit operating parameters representative of at least one of an accessory unit condition, an environmental condition and a heat exchange unit condition; controlling a functioning of at least one of the accessory unit and the heat exchange unit according to the control values and the received operating parameters.

According to another broad aspect of the present invention, there is provided a walk-in refrigerating unit comprising: a cold room with a controlled environment, a heat exchange unit for controlling the environment of the cold room and an electronic controller for monitoring and controlling at least one operating parameter of the unit, the electronic controller being connected to at least one peripheral monitoring at least one operating parameter.

According to another broad aspect of the present invention, there is provided a walk-in refrigeration unit comprising: a temperature probe located inside said unit for obtaining a temperature reading inside said unit; a door frame having a heating element that reduces humidity in the vicinity of said door frame; a controller obtaining said temperature reading and sending a control signal to said heating element to control an amount of heat generated by said heating element.

### BRIEF DESCRIPTION OF THE DRAWINGS

FIG. 1 is a perspective view of a walk-in refrigeration unit according to the preferred embodiment of the present invention; and

FIG. 2 is a block diagram of a walk-in refrigeration unit control and monitoring system according to the preferred embodiment of the present invention.

### DETAILED DESCRIPTION OF THE INVENTION

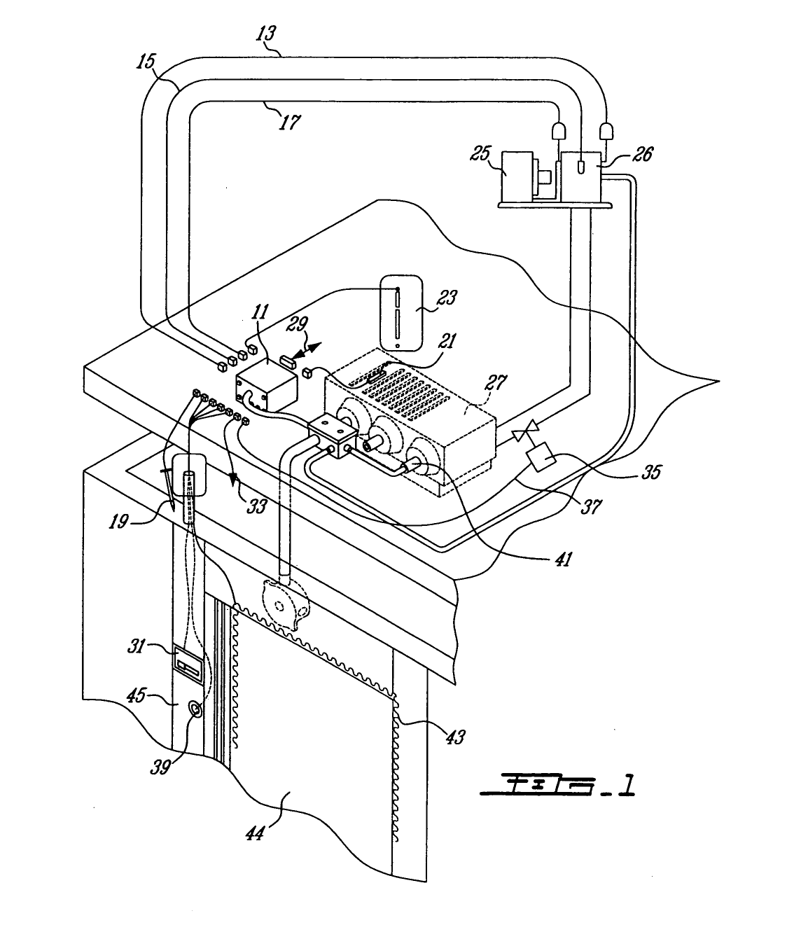

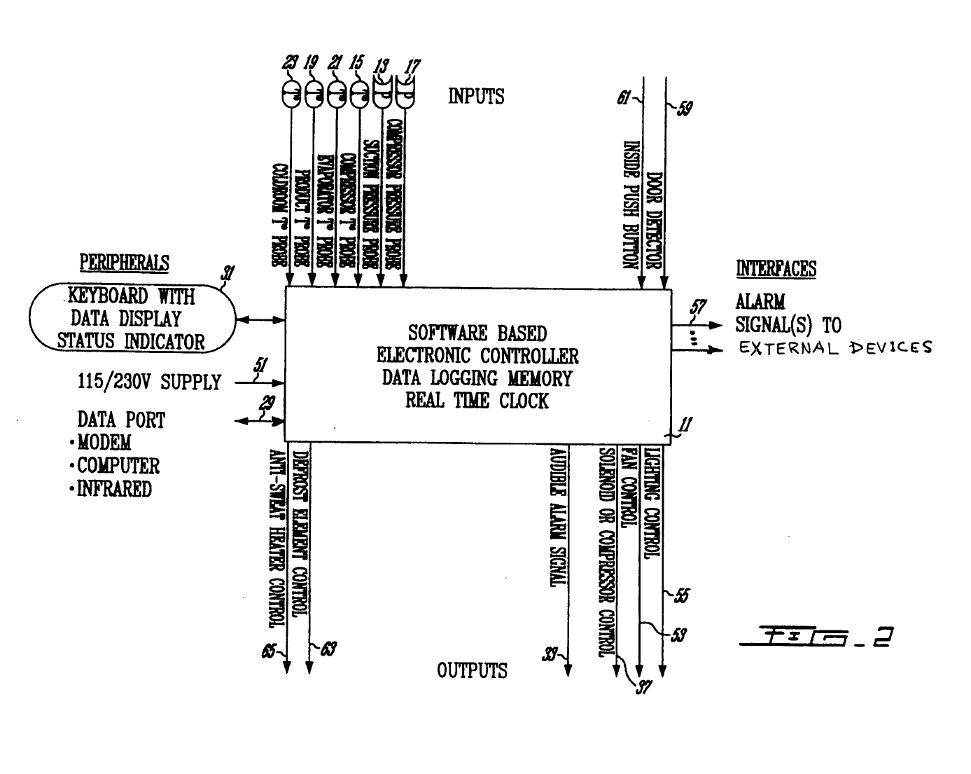

The preferred embodiment of the present invention will be described with reference to FIGS. 1 and 2. FIG. 1 illustrates a walk-in refrigerator unit according to the preferred embodiment of the present invention. In a cold room environment, such as the one provided by the walk-in refrigeration unit, there are different ways to control and to monitor the temperature, including mechanical devices and electronic controls.

The software-based electronic controller 11 is the unit that controls the walk-in refrigeration system by constantly monitoring its functioning. The refrigeration system of the walk-in refrigeration unit is completely managed by the electronic controller 11, whose functions include temperature regulation, defrost cycles and evaporator fan motor 41 interruptions. The electronic controller 11 is in communication with a heat exchange unit, which comprises a condenser 25, a compressor 26, an evaporator unit 27 and a solenoid valve 35.

The compressor 26 compresses a refrigerant gas and raises the refrigerant's pressure and temperature. The condenser 25 then receives the hot refrigerant gas and condenses it into liquid form at high pressure. A liquid line connects the condenser 25 to the evaporator unit 27. An expansion valve (not shown), prior to the evaporator unit 27, allows the cool liquid refrigerant to expand and evaporate as a gas. The evaporator unit 27 comprises an evaporator coil and an evaporator fan, driven by a fan motor.

The temperature regulation is achieved by measuring the air temperature inside the cold room and, adjusting it based on a user-defined set point and hysterisis. The temperature is controlled by either the solenoid valve 35 or the compressor 26. For example, when the refrigeration unit reaches a certain threshold temperature, the electronic controller 11 interrupts power to the solenoid valve 35 or to the compressor 26, which stops the refrigeration cycle.

A cold room door frame 45 often requires an accessory unit such as an anti-sweating heating element 43 to eliminate condensation in the door perimeter due to temperature differences between the inside of the cold room and the outside. The heating element 43 is controlled by the electronic controller 11. The anti-sweating heating element 43 preferably functions on a variable power cycle in order to reduce consumption. The electronic controller 11 receives operating parameters to control the condition of the accessory unit, in this case, the heating element, and controls, by means of a thermostat or a dimmer the power level of the anti-sweating heating element 43. In order to apply the proper amount of heating, the output is cycled on and off in time, for example, at 50% the output is on half of the time. Both activation temperature and power level are configurable by the menu mode of the electronic controller 11.

Whenever the door switch detects that the cold room door 44 is opened or whenever a user is working inside the cold room, the evaporator fan motor 41 is interrupted. When, for example, the evaporator fan 41 and solenoid valve 35 are turned off for too long, the temperature inside the cold room will rise at or over the high temperature alarm level. At that point, the evaporator fan 41 and solenoid valve 35 will resume into normal operation to lower the temperature in the cold room back to the set point. If the door is left opened for longer than a door open alarm delay, the evaporator fan 41 and solenoid valve 35 will also resume into normal operation.

The electronic controller 11 also features an option that manages the initial start-up of the refrigeration system. In order to prevent ice build-up in the evaporator coil 21 that some times occurs in the first cool down, the electronic controller 11 lowers the temperature in incremental temperature steps and initiates a defrost cycle between each of the steps until the final temperature is reached. This option can be programmed by selecting from the menu mode the range of the temperature steps.

The number of defrost cycles and their duration are defined either by a user or pre-set in registers. The electronic controller 11 manages the solenoid valve 35, the evaporator fans 41 and the defrost elements based on control values such as the evaporator coil temperature threshold or the maximum defrost time defined. As it will be described below, a manual defrost could also be initiated through the electronic controller keypad 31.

A digital control pad or keypad 31 is installed outside the cold room, preferably beside the cold room door 44 opening and recessed flush into the cold room door frame 45. Preferably, all the wiring is embedded in the insulation and leads out of the cold room for sanitary purpose. The keypad 31 is the interface providing access to the electronic controller settings and programs.

The keypad 31 includes keys with multiple functionalities, a data display readout and status indicators. The keypad 31 push buttons allow manual control of different parameters, such as lighting control, readout display data, alarm settings and system configuration. By accessing the menu mode, the system can be configured by setting control values, such as timers, set points, alarm levels and operation modes. The keypad menu also allows viewing the data logged in memory. The readout display allows viewing temperature, pressure, internal register values accessed by the menu, logged data, and short messages. The status indicators show the status of different system operating parameters, as well as indicate modes of operation and alarm status.

Light Control

Cold room lighting operation can be controlled with either the control keypad 31 or the button 39 inside the cold room. The light control can be configured in three different modes. The “AUTO” indicator on the keypad 31 shows the status of the selected mode: manual (indicator turned off), semi-automatic (indicator flashing) or automatic (indicator on). The modes can be selected from the menu of the control keypad 31.

In manual mode, the user presses a keypad 31 light key or the inside button 39 to turn light on or off. In semi-automatic mode, the light is turned on or off by the keypad 31 light key or the inside button. Light is automatically turned off when the door is closed, after a user defined delay which can be set in the keypad menu. Holding the keypad light key or inside button 39 for 1.5 seconds prevents the light from being turned off automatically.

The automatic mode allows turning on the light simply by opening the door of the cold room. This mode also includes all the other features of the semi-automatic mode. A status indicator shows the mode of operation and another status indicator shows if the light is either on, off or in a countdown cycle, represented by a flashing indicator.

In a large operation where the lighting could stay on during an entire day, a fourth mode would allow to control the lighting based on the time of the day. For example, the lights would be automatically turned on at 7:00 am and turned off at 6:00 pm. In this mode, the lighting could still be controlled manually by using the keypad 31 or the inside button 39. In order to prevent the light to shut off while there is somebody inside, a buzzer could give a warning a few minutes before shutting off.

Alarm Control

There are four types of alarms which can be generated by the system; High/Low temperature alarm, Door Alarm, Panic Alarm and refrigeration system Malfunction/Failure Alarm. Each one of these alarms must be activated and configured through control values stored in a register list. Using the menu mode, each alarm can be enabled or disabled and each one can be configured to send or not an outside signal through a dry contact.

When an event triggering an alarm occurs, the appropriate status indicator flashes on the keypad 31 and a local buzzer is activated according to the type of alarm. The buzzer can be silenced temporarily by pressing an acknowledge button on the keypad 31. The buzzer is reactivated after a Mute Alarm Disable Delay, the duration of which can be set through a control value in the register list. The buzzer can be permanently silenced by pressing twice the acknowledge button on the keypad 31. The alarm signal may also be sent to an external unit (not shown) to activate another device or for data logging.

The Hi/Lo temperature alarm level and the delay before activation are defined in the menu mode by the user. The user may set the High temperature Threshold, the Low Temperature Threshold and the Temperature Alarm Delay parameters from the register list.

The door open alarm is activated when the door is left open after a delay as defined by the Door Alarm Delay in the register list. In order to avoid a false alarm to the outside signal during normal operation, the outside signal, if selected, will be activated only if the door remains open three times longer than the pre-set Door Alarm Delay.

The panic alarm can only be activated when the door is closed, by holding the inside button 39 for a couple of seconds. Since the lighting control is also triggered by the inside button 39, the sequence will be that the light will turn on permanently if not already on and then the panic alarm will be activated. The panic alarm is cancelled by opening the door or by pressing the acknowledge key on the keypad 31.

The refrigeration system alarm is detected by the two pressure probes 13, 17 and the two temperature probes 15, 21 located in the evaporator coil 27 and on the compressor 26. Monitoring those operating parameters allows detecting gas leaks, dirty condenser, high temperature at condenser 25 or ice build-up in the evaporator coil 27.

Display of Temperature and Statistics

The keypad 31 allows displaying temperatures between −40 F and +125 F. If the temperature in the cold room exceeds these values, either −40 or +125 will flash on the keypad display 31. The keypad 31 provides a key allowing to toggle between C and F temperature measurements. The keypad 31 also provides keys for consulting the highest/lowest temperature reached in the monitored cold room.

When the door defrost option is selected, the heating element 43 is activated if the temperature is lower than the Door Defrost Activation Threshold parameter and power level for the heating element 43 is set by the Defrost Element Power value.

When the evaporator control is selected, the output 53 controls the evaporator fans 41 which are deactivated when the door is opened. If the door stays opened longer than the Door Alarm Delay value, then the evaporator fans 41 will be reactivated.

As illustrated in FIG. 2, the electronic controller 11 has an internal memory and a real time clock (RTC) for data logging. The configuration and the information recorded are accessible through the menu mode of the keypad 31. The system logs any alarm status combined with time, period and value of the parameter being in fault. The system is also configured to log, at given time intervals, some variables of the system such as inside cold room temperature, product temperature, evaporator coil temperature, compressor/condenser temperature, suction pressure and compressor pressure. The system also has the capability to log for a time interval (e.g. 24 hours), different status of the system as running time of the compressor, running time of the fans, running time for the defrost cycle, door open time and “light on” time. The system logs the highest and the lowest value reached of all analog inputs. Additionally, the system may be programmed to log any combination of the status or value from the inputs and outputs of the system.

The electronic controller 11 also provides different inputs/outputs as well as interfaces to communicate with peripherals, such as modems and computers. It includes a power failure back-up either by using a battery or a capacitor. The back-up allows maintaining the main functions of the system, such as monitoring, data logging and alarm signal during power failures.

The inputs/outputs and peripherals will now be described with reference to FIG. 2.

A temperature probe 23 input is provided to read air temperature inside the cold room to allow control, monitoring, alarm and data logging. The temperature probe 23 reading triggers the operation of the anti-sweat heating element 43 as well as temperature control and alarms.

A temperature probe 19 is provided to read food temperature inside the cold room to allow monitoring, alarm and data logging. Another temperature probe 21 reads the evaporator coil temperature which is used to control defrost cycles.

A temperature probe 15 reads the condenser 25 or compressor 26 temperature for equipment safety, prevention, and trouble shooting purposes. A suction pressure probe 13 is provided at the inlet of the compressor 26 and compressor pressure probe 17 is installed at the outlet of the compressor 26 for equipment safety, prevention and trouble shooting purposes.

A backlit push button 39 is to be installed inside the cold room, beside the door 44 opening and recessed flush into the door frame, with all the wiring embedded in the insulation and leading out of the cold room for sanitary purposes. The push button signal 61 is used to control the lighting in different modes, and can also be used to shut down temporarily the evaporator fans 41 and/or to trigger an audible alarm signal 33.

A door detector 59 is to be installed beside the door 44 opening and recessed flush into the door frame, with all the wiring embedded in the insulation and leading out of the cold room for sanitary purpose. The detector 59 triggers the automatic lighting control and/or the interruption of the evaporator fan 41 and solenoid valves 35 while the door is left opened.

An output 55 controls the lighting inside the cold room and another output 53 controls the evaporator fan 41, based on the control values configured in the electronic controller 11 and the operating parameters received at the inputs. Similarly, an output 37 controls either the liquid solenoid valve 35 or the compressor 26 itself.

An audible alarm signal 33 is wired to either a buzzer, a horn or both in order to trigger a local alarm. Another alarm signal 57 (or a multiplicity of alarm signals) can be sent to an outside alarm.

An output 63 controls the defrost elements in the evaporator based on the control values configured in the electronic controller 11 and the operating parameters received at the inputs.

An output 65 controls the anti-sweat heating element 43 to the proper level of power based on environmental requirement or based on the control values configured in the electronic controller 11 and the operating parameters received at the inputs. This allows energy saving with less heating requirement and prevents excess heating from being compensated by the refrigeration system.

With the different inputs, outputs and data communication capability all linked together in the electronic controller 11, it provides a tremendous amount of features and functionality that increase the efficiency of the overall operation in terms of accuracy, energy saving, safety, trouble shooting, prevention, maintenance and traceability. Using a single controller leads to cost savings as opposed to independent controlling and monitoring devices. From the architecture of the system, additional features and functionality may be added simply by revising the software in the electronic controller 11.

The electronic controller 11 features one or a few data ports 29 that allow communication with other peripherals, such as computers, modems or any other communication device. The link could be either by cable or infrared port. The communication ports 29 allow downloading data logged in the electronic controller 11 to an external device, such as a computer. The communication ports 29 also allow for sending alarm signals on line and monitoring of the refrigeration unit from a remote site. The communication ports 29 are preferably bidirectional, so that the functioning of the electronic controller and the setting of control values can be configured by uploading configuration information from an external device. The data port 29 also allows to link similar system into a network. The program, the configuration, any upgrade or revisions of the system could also be loaded by the data port 29.

The embodiments of the invention described above are intended to be exemplary only. The scope of the invention is therefore intended to be limited solely by the scope of the appended claims.

1. A method for monitoring and controlling a walk-in refrigeration unit, comprising:
setting at least one of a threshold value and a timing control value associated to operating modes of said refrigeration unit;
receiving, at a controller unit, operating parameters representative of a condition of at least one of an accessory unit, an environment and a heat exchange unit;
controlling a functioning of said at least one of said accessory unit and said heat exchange unit according to said control values and said received operating parameters.

2. A method as claimed in claim 1, further comprising comparing said operating parameters and said control values to determine an alarm condition and triggering an alarm upon detecting said alarm condition.

3. A method as claimed in claim 2, wherein said alarm is triggered locally.

4. A method as claimed in claim 1, further comprising displaying a status indicator for said at least one of said conditions.

5. A method as claimed in claim 1, further comprising providing a keypad control unit for said walk-in refrigeration unit and wherein said setting control values is carried out manually by using said keypad control unit.

6. A method as claimed in claim 1, wherein said controlling said heat exchange unit functioning comprises controlling a cycle of an evaporator for reduced energy consumption.

7. A method as claimed in claim 1, wherein said accessory unit is a heating element and wherein controlling said accessory unit functioning comprises controlling an on/off cycle of said heating element for performing a defrost cycle of said walk-in refrigeration unit.

8. A method as claimed in claim 1, wherein said receiving said operating parameters representative of an environmental condition comprises receiving a value of at least one of an air temperature inside said refrigeration unit, air humidity inside said refrigeration unit, food temperature inside said refrigeration unit and an air temperature outside said refrigeration unit.

9. A method as claimed in claim 1, further comprising sending said received operating parameters to an external unit for remote monitoring.

10. A method as claimed in claim 1, wherein said setting at least one of a threshold value and a timing control value comprises receiving configuration values from an external unit.

11. A method as claimed in claim 1, further comprising storing said received operating parameters in a local memory.

12. A method as claimed in claim 10, further comprising monitoring said stored operating parameters.

13. A walk-in refrigeration unit comprising:
a temperature probe located inside said unit for obtaining a temperature reading inside said unit;
a door frame having a heating element that reduces humidity in the vicinity of said door frame;
a controller obtaining said temperature reading and sending a control signal to said heating element to control an amount of heat generated by said heating element.

14. A walk-in refrigerating unit comprising:
a cold room with a controlled environment;
a heat exchange unit for controlling the environment of said cold room;
an electronic controller for monitoring and controlling at least one operating parameter of said unit, said electronic controller being connected to at least one peripheral monitoring said at least one operating parameter.

15. A walk-in refrigerating unit as claimed in claim 14, wherein said at least one peripheral comprises a temperature probe and said at least one operating parameter comprises temperature.

16. A walk-in refrigerating unit as claimed in claim 14, further comprising an alarm unit in connection with said electronic controller.

17. A walk-in refrigerating unit as claimed in claim 14, wherein said electronic controller further comprises means for interfacing with external data communication devices.

18. A walk-in refrigeration unit as claimed in claim 17, wherein said means for interfacing with external data communication devices comprise means for receiving configuration information from an external device allowing to configure said refrigeration unit.

19. A walk-in refrigerating unit as claimed in claim 14, wherein said electronic controller further comprises a memory unit for logging said operating parameters of said unit.

20. A walk-in refrigerating unit as claimed in claim 14, further comprising a keypad control unit for configuring said electronic controller.

21. A walk-in refrigeration unit as claimed in claim 14, further comprising a heating element for eliminating condensation in a refrigeration unit door perimeter due to temperature differences, said heating element being controlled by said electronic controller.

22. A walk-in refrigeration unit as claimed in claim 14, further comprising a button connected to said electronic controller, for manually controlling a lighting inside said refrigeration unit.

23. A walk-in refrigeration unit as claimed in claim 14, wherein said at least one peripheral is selected from the list comprising:
a. a temperature probe to read air temperature inside said unit;
b. a temperature probe to read food temperature inside said unit;
c. a temperature probe to read evaporator coil temperature;
d. a temperature probe to read condenser or compressor temperature;
e. a suction pressure probe at the inlet of the compressor;
f. a compressor pressure probe at the outlet of the compressor;
g. a backlit push button installed inside said unit;
h. a door detector switch;
i. a user interface device installed outside said unit;
j. an output to said light;
k. an output to the evaporator fan;
l. an output to control either the liquid solenoid valve or the compressor;
m. an audible alarm device;
n. alarm signal to external devices;
o. a keyboard;
p. data port;
q. an output to control the defrost elements; and
r. an output to control the anti-sweat heater element.
